(19) United States
(12) Patent Application Publication
(10) Pub. No.: US 2016/0243976 A1
(43) Pub. Date: Aug. 25, 2016

(54) CARGO LOAD LOCK SYSTEM

(71) Applicant: Aaron Cote, Phoenix, AZ (US)

(72) Inventor: Aaron Cote, Phoenix, AZ (US)

(21) Appl. No.: 14/631,730

(22) Filed: Feb. 25, 2015

(51) Int. Cl. B60P 7/15

(52) U.S. Cl. CPC B60P 7/15

(57) ABSTRACT

The present invention relates to cargo load lock system. The cargo load lock may include an upper foot, a telescoping tubular pole, a gripping foot and a pair of forks. The cargo load lock may be coupled to a pallet by the pair of forks to better secure cargo against a surface within a cargo carrier in order to keep the cargo in place. The cargo load lock system includes a device for tightening the upper foot and the gripping foot against a pallet and the interior portion of the cargo truck or the trailer, the device for tightening is adapted to shorten or extend the length of the telescoping tubular pole in a secure position. The gripping foot may have the pair of forks, a housing with a plurality of nubs and corresponding holes or a fork plate to accommodate insertion into the pallet.

### BACKGROUND OF THE INVENTION

1. Field of the Invention

The present invention relates to cargo restraining devices, and more particularly, an improved cargo load lock system.

2. Description of the Related Art

Cargo load locks, sometimes called load bars, are basically telescoping bars or poles, having gripping feet at either end, and a ratcheting device for tightening the feet against two surfaces, usually trailer walls, floors, ceilings, or a combination thereof. These cargo load locks are typically utilized to brace cargo from shifting backward or forward in a trailer. The foot of a cargo load lock is usually square or rectangular, and has a rubberized gripping surface on one side. They are no larger than five or six inches on any side. However, if a cargo load lock is placed between freight and a vehicle wall, horizontally, the cargo may easily be punctured by the cargo load lock foot.

### SUMMARY OF THE INVENTION

One aspect of the disclosure relates to a cargo load lock system that utilizes a pallet that is coupled to a first end of a cargo load lock. The pallet may be a wooden pallet, a plastic pallet or the like. The cargo load lock may include an upper foot, a telescoping tubular pole, a gripping foot including a pair of forks, and a device for tightening the feet against a pair of surfaces. In an embodiment, the device for tightening the feet against a pair of surfaces is a ratcheting device. In an embodiment, a housing having a pair of forks will receive the gripping foot and a force from the cargo load lock system in an extended mode. The pair of forks will extend into a pallet to better secure cargo against a surface within a cargo carrier in order to keep the cargo in place.

The cargo load lock system further may include a plurality of nubs disposed on the sides of the gripping foot that correspond to a plurality of holes formed on the walls of the housing to accommodate the nubs. In another embodiment, the housing may have a plurality of flexible walls to encase the gripping foot. In another embodiment, the housing may be coupled to a fork plate with a pair of forks to extend into a pallet to better secure cargo against a surface within a cargo carrier in order to keep the cargo in place.

The cargo load lock system further may include a first end of a telescoping tubular pole being coupled to a fork plate with a pair of forks to extend into a pallet to better secure cargo against a surface within a cargo carrier in order to keep the cargo in place. In another embodiment, the pair of forks may be angled upwards or downwards along an x-axis of the pair of forks to better couple a pallet to the pair of forks.

### BRIEF DESCRIPTION OF THE DRAWINGS

FIG. 1 illustrates an environmental view of a cargo load lock system in operation, according to an embodiment;

FIG. 2 illustrates a perspective view of a cargo load lock, according to an embodiment;

FIG. 3 illustrates a cargo load lock in relation to a pallet and a piece of cargo;

FIGS. 4 to 9 illustrate various other embodiments and variations of the present invention.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

### DETAILED DESCRIPTION OF THE INVENTION

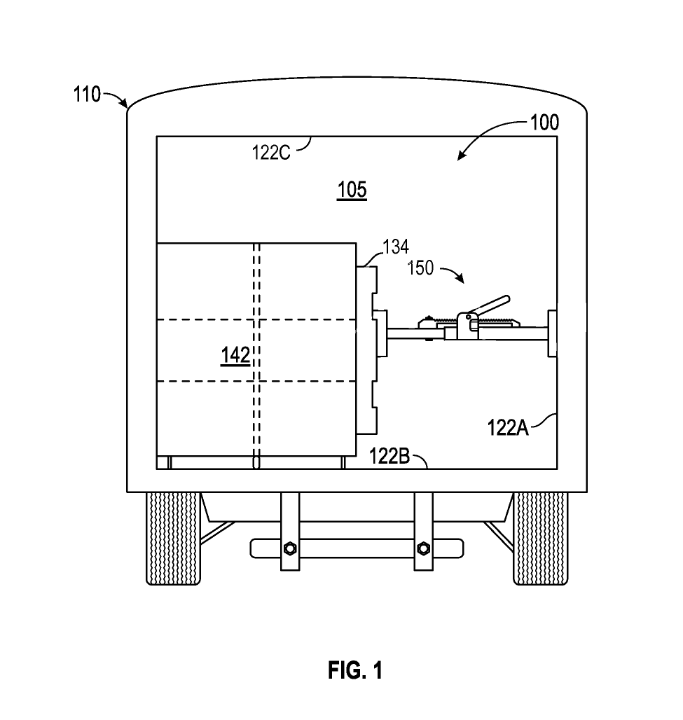

FIG. 1 illustrates an environmental view of a cargo load lock system 100 in operation. The cargo load lock system is disposed inside of an interior portion 105 of a cargo truck 110, trailer or the like. The cargo load lock system 100 includes a cargo load lock 150 used to secure cargo 142 disposed within the interior portion 105 of the cargo truck 110.

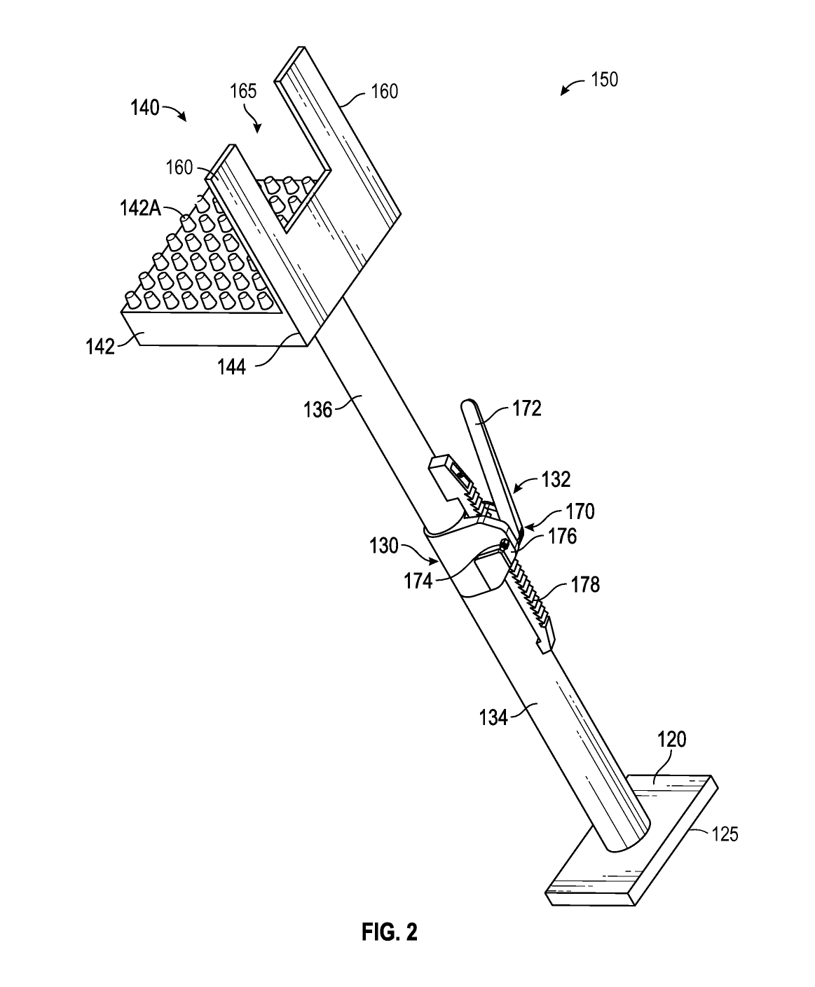

FIG. 2 illustrates a perspective view of the cargo load lock 150, according to an embodiment. As shown, the cargo load lock 150 includes an upper foot 120, a telescoping tubular pole 130, and a gripping foot 140 including a pair of forks 160. The gripping foot 140 includes a vertical facing 142. The vertical facing 142 may have a raised texture 142A or the like to better secure a pallet 134. The pair of forks 160 extend from a top edge 144 of the vertical facing 142. A notch 165 is disposed between the pair of forks 160 to insure better penetration of the pair of forks 150 into the pallet 134.

The upper foot 120 can have a flat surface 125 that may be in direct contact with an interior wall 122A of an interior portion 105 of the cargo truck 110 or the trailer 110A or the like. The flat surface 125 may also be in contact with an interior floor 122B, an interior ceiling 122C, or the like. The flat surface 125 may have a generally planar rectangular shape or the like. The telescoping tubular pole 130 may have a first end and a second end. The telescoping tubular pole 130 may be a telescoping tubular pole or the like. The upper foot 120 is be disposed on the first end of the telescoping tubular pole 130. The telescoping tubular pole 130 may include a device for tightening 132 the upper foot 120 and the gripping foot 140 against a pallet 134 and the interior portion 105 of the cargo truck 110 or the trailer 110A. The device for tightening 132 may be adapted to shorten or extend the length of the telescoping tubular pole 130 in a secure position. The gripping foot 140 may be coupled on the second end of the telescoping tubular pole 130. The gripping foot 140 may secure the cargo 142 disposed within the interior portion 105 of the cargo truck 110 or the trailer 110A.

The device for tightening 132 may be a ratcheting device 170 that may be adapted to shorten or extend the length of the telescoping tubular pole 130 in a secure position. The ratcheting device 170 may be disposed on the first portion 134 of the telescoping tubular pole 130. The ratcheting device 170 may have a handle 172, a gear 174, a pawl 176 and a plurality of teeth 178. The handle 172 may be pulled to adapt the ratcheting device 170 to shorten or extend the length of the telescoping tubular pole 130 and to secure the telescoping tubular pole 130 in place. The gripping foot 140 may have a vertical facing 142.

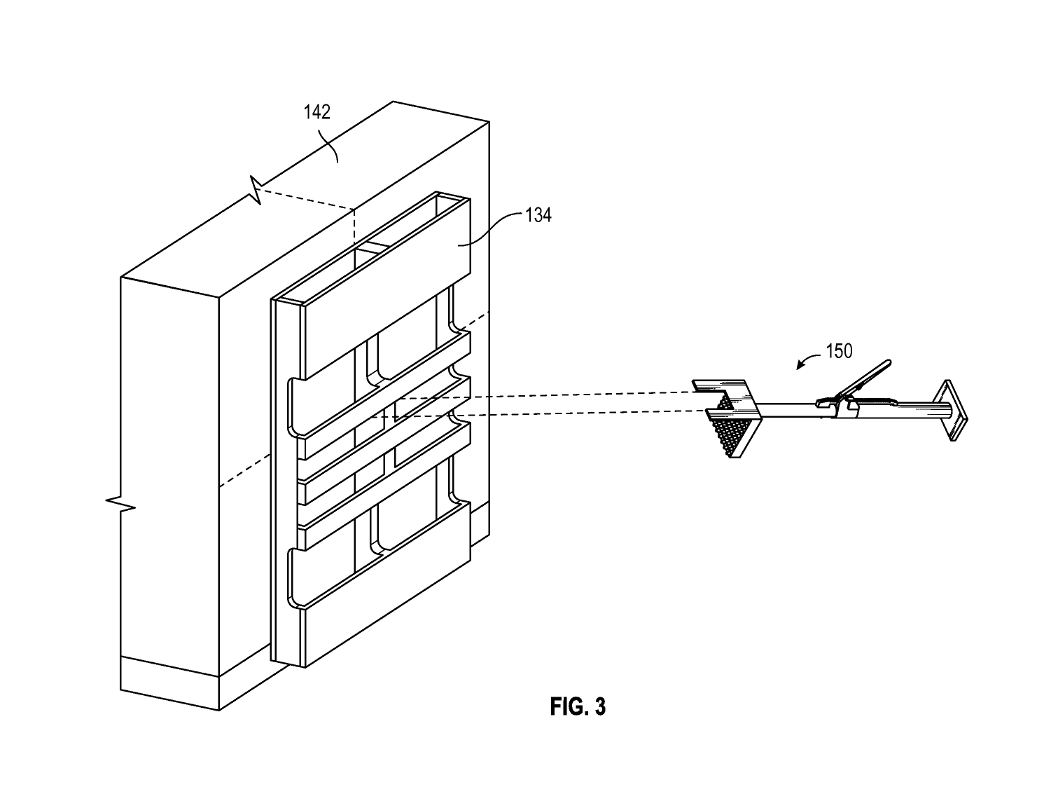

FIG. 3 illustrates the cargo load lock 150 in relation to the pallet 134 and a piece of cargo 142. The pallet 134 may be made of wood, plastic or the like. The cargo 142 may easily be punctured by a relatively smaller surface area of a traditional gripping foot. An advantage of the cargo load lock 150 is to provide a significantly greater surface area in contact with the cargo 142 than traditional cargo load lock devices, thereby better securing the cargo 142 within a cargo truck (FIG. 1, 110) or trailer, or the like.

In order to utilize the cargo load lock system 100, a user must understand how a typical wooden pallet 134 or the like is constructed. Lean an empty wooden pallet 134 against the cargo 142. Position the pair of forks 140 on either side of a middle two by four of the empty wooden pallet 142. The pair of forks 140 may be inserted between the slats of the pallet, thereby allowing a greater number of choices in placement (i.e., closer to the center of gravity of the cargo is relatively more stable than other locations of the pallet). The cargo load lock system 100 aligns the gripping foot 160 centrally over the middle two-by-four. The cargo load lock 150 is then tightened with the ratcheting device 170 against a wall of a trailer or a cargo truck or the like.

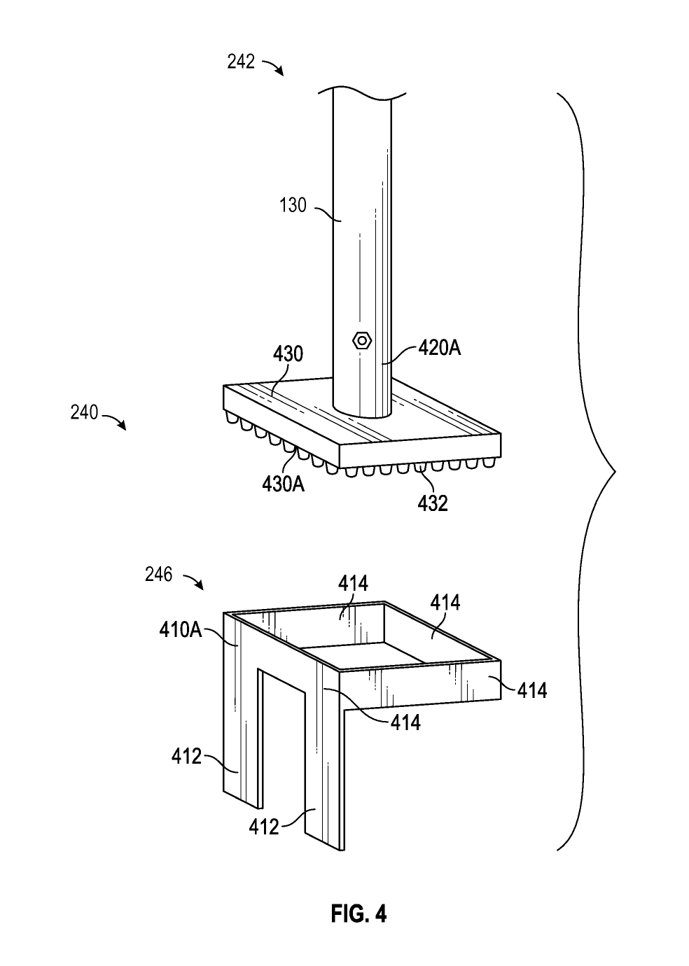

FIG. 4 illustrates a gripping foot 240 of the cargo load lock, according to another embodiment. As shown, the gripping foot 240 includes an upper gripping foot portion 242 and a lower gripping foot portion 246. The upper gripping foot portion includes the telescoping tubular pole 130 and a gripping foot 430. The telescoping tubular pole 130 has a first end 420A and the gripping foot 430 is coupled to the first end 420A of the telescoping tubular pole 130. The upper gripping foot portion 242 has a front facing 430A which includes a rubberized gripping surface 432 disposed on the front facing 430A. The lower gripping foot portion 246 includes a pair of forks 412 and a plurality of flexible walls 414. The pair of forks 412 is disposed on a top edge 410A. The lower gripping foot portion 246 can be inserted into the upper gripping foot portion 242, which corresponds and fits into the upper gripping foot portion 242. The lower gripping foot portion 246 may be kept in place by friction from the rubberized gripping surface 432. The flexible walls 414 may envelope the gripping foot 430 in order to keep it in place. The gripping foot 430 may provide force from the telescoping tubular pole 420 to hold the housing 410 on the gripping foot 430 while the pair of forks 412 couple the pallet (FIGS. 1 and 3, 134).

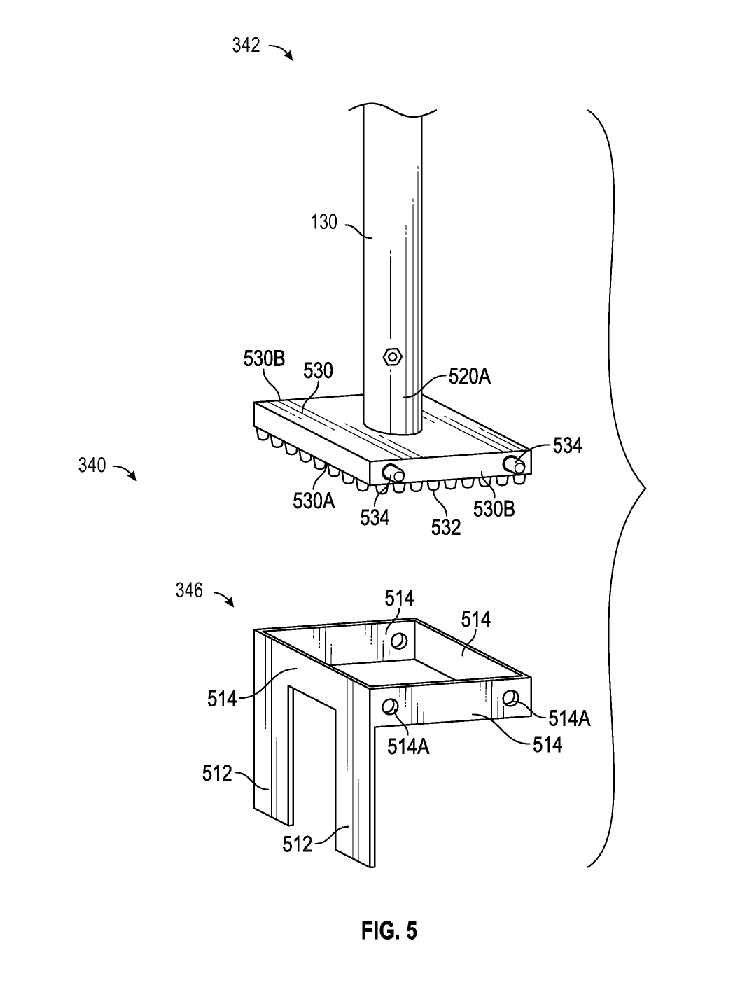

FIG. 5 illustrate a gripping foot 340 of the cargo load lock, according to yet another embodiment. As shown, the gripping foot 340 includes an upper gripping foot portion 342 and a lower gripping foot portion 346. The upper gripping foot portion 342 includes the telescoping tubular pole 130 and a gripping foot 530. The telescoping tubular pole 130 has a first end 520A. The gripping foot 530 is coupled to the first end 520A of the telescoping tubular pole 130. The gripping foot 530 has a front facing 530A which may include a rubberized gripping surface 532 disposed on the front facing 530A. The gripping foot 530 may include a plurality of nubs 534 disposed on a plurality of sides 530B. The lower gripping foot portion 346 includes a pair of forks 512 and a plurality of flexible side walls 514. The pair of forks 512 are disposed on a top edge 530C of the housing 510. The side walls 514 include a plurality of holes 514A that correspond to the nubs 534 disposed on the sides 530B of the gripping foot 530. The lower gripping foot portion 346 can be inserted into the upper gripping foot portion 342, which corresponds and fits into the upper gripping foot portion 342. The lower gripping foot portion 346 is kept in place by friction from the rubberized gripping surface 532 and the holes 514A accommodating the nubs 534. The flexible side walls 514 may facilitate the holes 514A accommodating the nubs 534 and enveloping the gripping foot 530 in order to keep the gripping foot 530 in place.

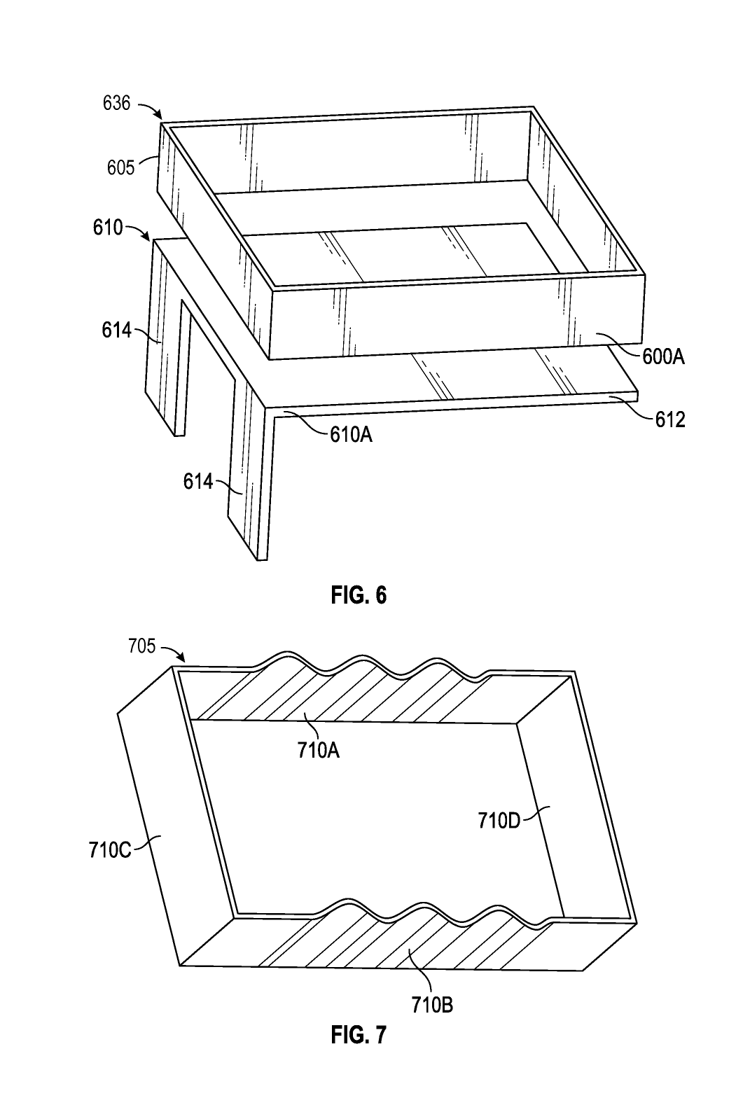

FIG. 6 illustrate a lower gripping foot portion 636 which may be used in place of the lower gripping portion 246 (FIG. 4), according to an embodiment. The lower gripping foot portion 636 includes a frame 605 and a fork plate 610. The frame 605 can be made of flexible material such as rubber or the like. The fork plate 610 includes a planar base plate 612 and a pair of forks 614. The planar base plate 612 may be coupled to a bottom 600A of the frame 605. More specifically, the planar base plate 612 may be molded around the bottom 600A. The pair of forks 614 are disposed on a top edge 610A of the fork plate 610 pointing away from the housing 600. The planar base plate 612 and the fork plate 610 may be made of rigid material such as steel or the like. The lower gripping foot portion 646 can be inserted into the upper gripping foot portion 242, which corresponds and fits into the upper gripping foot portion 242.

FIG. 7 illustrate a frame 705 which may be used in place of the lower gripping foot portion 636 (FIG. 6), according to an embodiment. The frame 705 includes a first wall 710A, a second wall 710B, a third wall 710C and a fourth wall 710D. The first wall 710A and the second wall 710B are made of flexible material such as rubber or the like. The third wall 710C and the fourth wall 710D are made of rigid material such as steel or the like.

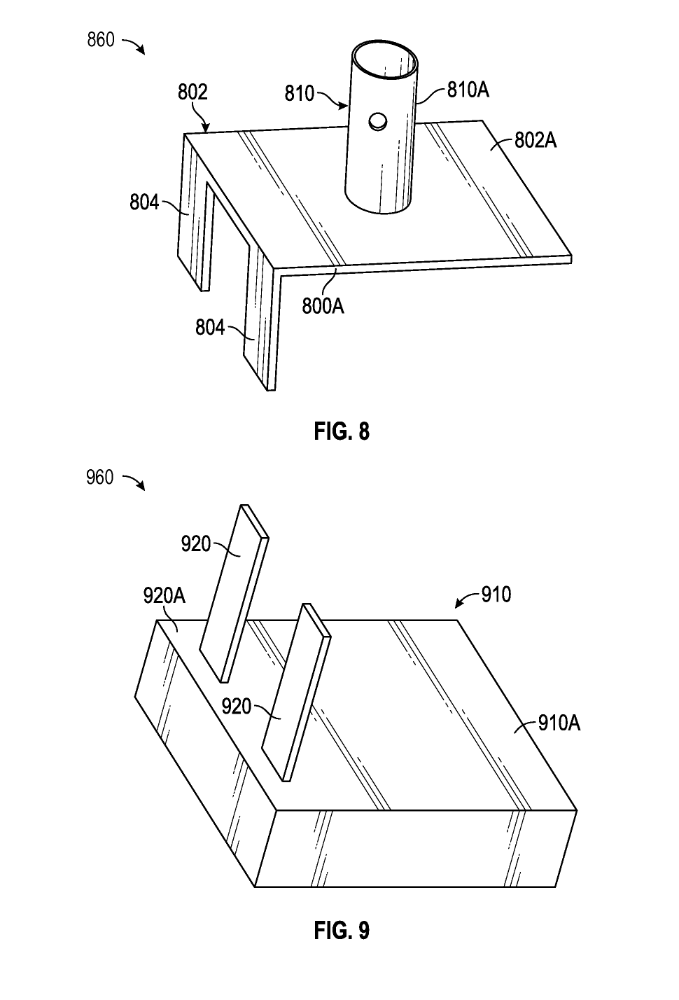

FIG. 8 illustrates a gripping foot 860, according to another embodiment. The gripping foot 860 may be used in place of the gripping foot 160 (FIG. 2). The gripping foot 860 includes a planar base plate 802 and a pair of forks 804. The telescoping tubular pole 810 may have a first end 810A. The planar base plate 802 may include a center portion 802A which may be coupled to the first end 810A of the telescoping tubular pole 130 (FIG. 2). The pair of forks 804 may be disposed on a top edge 800A of the fork plate 800 pointing away from the telescoping tubular pole 810.

FIG. 9 illustrates a gripping foot 960, according to another embodiment. The gripping foot 860 includes a housing 910 and a pair of forks 920. The housing 910 may include a back side 910A. The pair of forks 920 may be disposed on a top portion 920A of the back side 910A of the housing 910. The pair of forks 920 may be angled upwards or downwards along an x-axis of the pair of forks 920 to better couple a wooden pallet (FIG. 3, 210) to the pair of forks 920.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. A cargo load lock system, comprising:
an upper foot having a substantially flat surface;
a pole having a first end and a second end, the upper foot disposed on the first end of the pole;
a gripping foot coupled on the second end of the pole;
a device for tightening the upper foot against a pallet and the gripping foot against an interior portion of a cargo truck, the device for tightening adapted to shorten or extend the length of the pole in a secure position; and
a pair of forks disposed on a top portion of the gripping foot to accommodate insertion of the pair of forks into the pallet disposed on cargo, the pair of forks having substantially straight sides.

2. The cargo load lock system according to claim 1, wherein the gripping foot has a vertical facing with a raised texture to secure the pallet.

3. The cargo load lock system according to claim 1, wherein the device for tightening is a ratcheting device.

4. The cargo load lock system according to claim 1, wherein the pair of forks includes a notch disposed between the pair of forks to insure better penetration of the pair of forks into the pallet.

5. (canceled)

6. A cargo load lock system, comprising:
an upper foot having a flat surface, the flat surface in direct contact with an interior wall, an interior floor, an interior ceiling of an interior portion of a cargo truck or a trailer;
a telescoping tubular pole having a first end and a second end, the upper foot disposed on the first end of the telescoping tubular pole;
a gripping foot coupled on the second end of the telescoping tubular pole, the gripping foot has a front facing which includes a rubberized gripping surface disposed on the front facing;
a device for tightening the upper foot and the gripping foot against a pallet and the interior portion of the cargo truck or the trailer, the device for tightening is adapted to shorten or extend the length of the telescoping tubular pole in a secure position; and
a housing having a pair of forks and a plurality of flexible side walls, the pair of forks disposed on a top edge of the housing, the gripping foot is inserted into the housing and corresponds and fits into the housing, the housing kept in place by friction from the rubberized gripping surface and the flexible side walls enveloping the gripping foot in order to keep the gripping foot in place.

7. The cargo load lock system according 6, wherein the gripping foot provides force from the telescoping tubular pole to hold the housing on the gripping foot while the pair of forks couple the pallet.

8. The cargo load lock system according 7, wherein the gripping foot includes a plurality of nubs disposed on a plurality of sides.

9. The cargo load lock system according 8, wherein the flexible side walls include a plurality of holes that correspond to the nubs disposed on the sides of the gripping foot.

10. The cargo load lock system according 9, wherein the housing is kept in place by friction from the rubberized gripping surface and the holes accommodating the nubs.

11. The cargo load lock system according 10, wherein the flexible side walls facilitate the holes accommodating the nubs and enveloping the gripping foot in order to keep the gripping foot in place.

12. The cargo load lock system according 6, wherein the device for tightening is a ratcheting device disposed on a first portion of the telescoping tubular pole.

13. The cargo load lock system according 6, wherein the pair of forks includes a notch disposed between the pair of forks to insure better penetration of the pair of forks into the pallet.

14. The cargo load lock system according 6, wherein the flexible side walls are made of rubber.

15. A cargo load lock system, comprising:
an upper foot having a flat surface, the flat surface in direct contact with an interior wall, an interior floor, an interior ceiling of an interior portion of a cargo truck or a trailer;
a telescoping tubular pole having a first end and a second end, the upper foot disposed on the first end of the telescoping tubular pole;
a gripping foot coupled on the second end of the telescoping tubular pole, the gripping foot has a front facing which includes a rubberized gripping surface disposed on the front facing; and
a device for tightening the upper foot and the gripping foot against a pallet and the interior portion of the cargo truck or the trailer, the device for tightening is adapted to shorten or extend the length of the telescoping tubular pole in a secure position.

16. The cargo load lock system according 15, wherein the gripping foot is a fork plate with a pair of forks.

17. The cargo load lock system according 15, further comprising a housing with the pair of forks disposed on a top portion of a backside of the housing.

18. The cargo load lock system according 17, wherein the pair of forks includes a notch disposed between the pair of forks to insure better penetration of the pair of forks into the pallet.

19. The cargo load lock system according 18, wherein the pair of forks is angled upwards or downwards along an x-axis of the pair of forks to better couple a wooden pallet to the pair of forks.

20. The cargo load lock system according 15, wherein the device for tightening is a ratcheting device disposed on a first portion of the telescoping tubular pole.
